(19) United States
(12) Patent Application Publication
(10) Pub. No.: US 2004/0231837 A1
(43) Pub. Date: Nov. 25, 2004

(54) Food server fluid level control

(75) Inventors: Jeffrey T. Zank, Germantown, WI (US); Ronald E. Bratton, Fort Wayne, IN (US)

Correspondence Address: FOLEY & LARDNER, 777 EAST WISCONSIN AVENUE, SUITE 3800, MILWAUKEE, WI, 53202-5308, US

(73) Assignee: The Vollrath Company, L.L.C.

(21) Appl. No.: 10/801,102

(22) Filed: Mar. 15, 2004

Related U.S. Application Data
(60) Provisional application No. 60/455,060, filed on Mar. 14, 2003.

(51) Int. Cl. A23B 4/12

(52) U.S. Cl. 166/125; 99/516

(57) ABSTRACT

A food serving station includes a support structure, one or more wells supported by the support structure, a drain manifold fluidly coupled to each of the one or more wells and not fluidly coupled to any other wells and a fill valve coupled to the drain manifold and external to the one or more wells and is adapted to be coupled to a fluid source. The valve is movable between an open position in which fluid from the fluid source is permitted to flow into the manifold in a closed position. The at least one sensor is configured to identify a volume of fluid within the interior.

### CROSS-REFERENCE TO RELATED APPLICATIONS

The present application claims priority under 35 U.S.C. § 119(e) from co-pending U.S. Provisional Patent Application Serial No. 60/455,060 filed on Mar. 14, 2003 by Jeffrey T. Zank and Ronald E. Bratton, and entitled “FOOD SERVER FLUID LEVEL CONTROL”, the full disclosure of which is hereby incorporated by reference.

### BACKGROUND OF THE INVENTION

Food servers generally comprise structures that include one or more wells configured to extend below and partially about one or more food containers or pans. The wells are generally configured to contain a heating or cooling medium which maintains the temperature of the food within the food pan. One known food server includes a plurality of wells. Each of the plurality of wells is provided with a drain outlet which communicates with a drain manifold connected to a drain. One of the plurality of wells (“sensor well”) additionally includes a sensor port, a fill port and an overflow port. A sensor or probe is mounted in the sensor port and extends within the interior of the sensor well. The sensor senses the level of water within the sensor well. When the level of water within the sensor well falls below a predetermined level, a fill valve is opened to supply water to the sensor well through the fill port. When the water within the sensor well is at or above a predetermined level, the fill valve is closed to cessate the supply of water to the sensor well. Water supplied to the sensor well flows through the drain port into the drain manifold and up through the drain ports of other wells. As a result of gravity, the level of water within all of the plurality of wells levels out and is generally the same. Water may be drained from each of the plurality of wells by opening a drain valve connected to the drain manifold. In circumstances where the sensor fails, excess water supplied to the wells is drained through the overflow port to the drain.

Although representing an advance in the art as compared to previous servers which required that the wells be manually filled with water and repeatedly checked to ensure an adequate level of water within the wells, this known server is extremely costly to inventory and manufacture. In particular, the sensor well of this system requires multiple ports: a drain port, a sensor port, an overflow port and a fill port. Forming such multiple ports in the well adds to the cost of manufacturing the server. In addition, maintaining inventories of wells having a single drain port and other wells requiring four ports requires valuable space and further adds cost to the manufacture of such servers.

### BRIEF DESCRIPTION OF THE DRAWINGS

FIG. 1 is a perspective view of a food serving station according to one exemplary embodiment of the present invention.

FIG. 2 is a schematic view of the food serving station of FIG. 1.

FIG. 3 is a side elevational view illustrating another embodiment of the food serving station shown in FIGS. 1 and 2.

FIG. 4 is a schematic illustration of another embodiment of the food serving station of FIGS. 1 and 2.

### DETAILED DESCRIPTION OF THE PREFERRED EMBODIMENTS

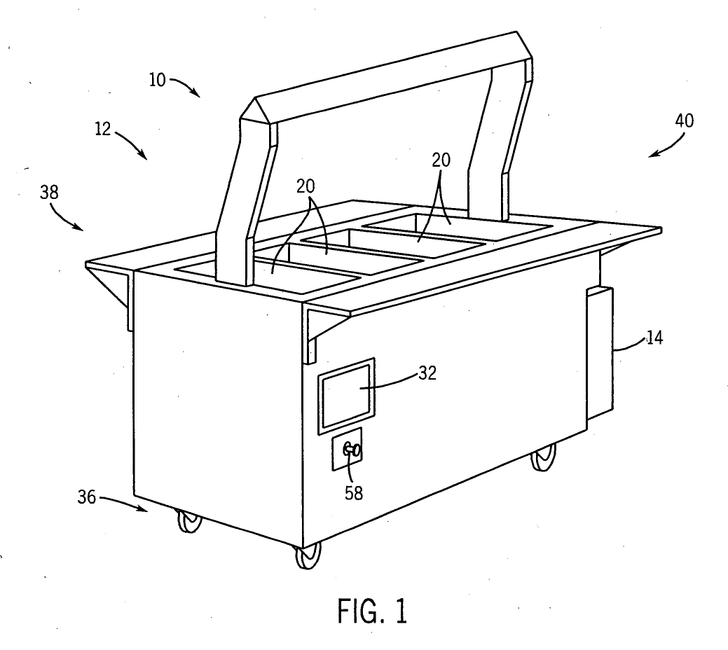

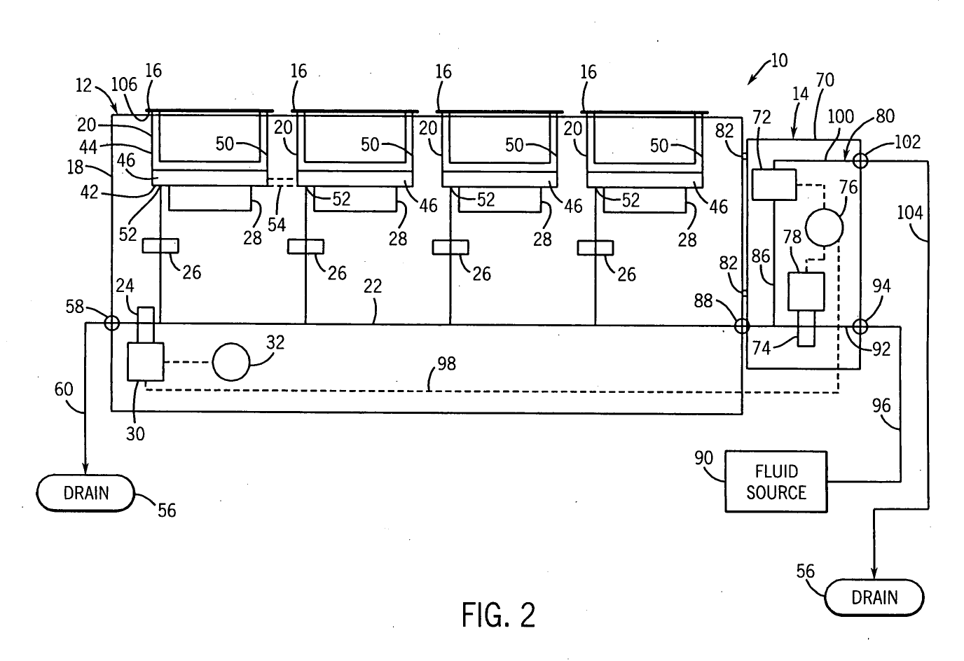

FIGS. 1 and 2 illustrate food serving station 10. FIG. 1 is a top perspective view of food serving station 10 while FIG. 2 is a schematic view of food serving station 10. Food serving station 10 generally includes server 12, water level control system 14 and food pans 16 (shown in FIG. 2). Server 12 generally includes support structure 18, wells 20, drain manifold 22, drain valve 24, individual well valves 26, heat sources 28, actuator 30 and controller 32. Support structure 18 generally comprises a structure configured to support wells 20 and to preferably house or surround drain manifold 22 and heat sources 28. In the particular embodiment illustrated, support structure 18 generally comprises a housing which additionally surrounds drain manifold 22 and heat sources 28 as well as the remaining components of server 12. In alternative embodiments, in lieu of forming an enclosure, support structure 18 may alternatively be open in nature so as to expose one or more components of server 12. Although server 12 is illustrated as generally comprising a portable server having wheels 36, a counter 38 and a sneeze guard 40, server 12 may alternatively be stationary in nature and may omit one or more of wheels 36, counter 38 or sneeze guard 40. In lieu of supporting four wells 20, support 18 may alternatively support one well 20, two or three wells 20, or more than four wells 20.

Each well 20 generally comprises a basin having a plurality of walls including a bottom or floor 42 and side walls 44 which form an opening configured to partially receive food pans 16 and configured to contain a fluid 46, such as water, below food pan 16. In one embodiment, wells 20 are permanently fixed to support structure 18. In another embodiment, wells 20 are removably coupled to support structure 18 such as being dropped into a cavity or framework provided by support structure 18.

Drain manifold 22 generally comprises one or more tubes, conduits, pipes or the like interconnected to one another so as to direct the flow of fluid. Drain manifold 22 is fluidly coupled to each of wells 20 and is not fluidly coupled to any other wells associated with server 12. For purposes of this disclosure, the recitation that two members or structures are “fluidly coupled” to one another or in “fluid communication” with one another shall mean that a direct or indirect conduit, passageway or flow path exists between the fluid containing or fluid guiding interiors of the two structures. Such a flow path may exist even though the flow path may be temporarily blocked by an actuatable valve mechanism. In the particular embodiment shown in FIG. 2, the interior fluid containing or fluid directing portions of drain manifold 22 is directly coupled to each of the interiors 50 of wells 20 via drain ports 52 formed in the floor 42 of wells 20. In alternative embodiments, drain manifold 22 may be indirectly fluidly coupled to one or more of wells 20 via an intermediate conduit extending between two or more of wells 20. For example, two wells 20 may alternatively be fluidly connected to one another by an intermediate conduit 54, eliminating the need for drain manifold 22 to be directly coupled to at least one of the wells 20 and further eliminating the need for a drain port 52 in one of the wells 20.

Drain manifold 22 is further fluidly coupled to a drain 56. Drain 56 may comprise a pail, bucket or other means for containing fluids drained through drain manifold 22 or may comprise permanent draining structures such as a plumbing network drain provided in a building in which server 12 is located. As shown by FIG. 2, drain manifold 22 preferably terminates at a coupling point 58 along the exterior of structure 18. Coupling point 58 is configured to be coupled to hoses, pipes or other structures 60 which direct the fluids to drain 56. In one embodiment, coupling point 58 may comprise a threaded end configured to threadably engage to a correspondingly threaded portion of a hose. FIG. 1 illustrates one preferred location of coupling point 58 concealed behind a door or panel.

Drain valve 24 generally comprises a conventionally known or future developed valving mechanism situated along drain manifold 22 between each of the portions of drain manifold 22 coupled to wells 20, collectively, and drain 56. Drain valve 24 moves between an open position in which fluid within drain manifold 22 is permitted to flow to drain 56 and a closed position in which fluid within drain manifold 22 is prevented from escaping from drain manifold 22.

Individual well valves 26 comprise conventionally known or future developed valve mechanisms situated along drain manifold 22 so as to selectively interrupt fluid communication between an individual one of wells 20 and the remainder of drain manifold 22. Each of drain valves 26 is movable between an open position in which fluid is permitted to pass through valve 26 and a closed position in which valve 26 blocks the flow of fluid. Valves 26 enable individual wells 20 to be filled or to be emptied independent of other wells 20.

Heat sources 28 generally comprise conventionally known or future developed mechanisms configured to deliver energy or heat to fluid 46 contained within each of wells 20. In one particular embodiment, at least the floor 42 of wells 20 are formed from a highly thermally conductive material, such as metal, wherein heat sources 28 generate or transmit heat to floor 42 which is further conducted to the fluid 46. In still other embodiments, heat source 28 may extend into the interior of each of wells 20 into direct or indirect contact with fluid 46. Examples of known heat sources 28 include fuel powered burners, electrically powered heat generating resistive elements (such as Calrods) or induction heat generating devices.

Heat sources 28 enable server 12 to function as a hot or warm food server. In operation, heat supplied to fluid 46 causes the fluid to change into steam. This steam transmits heat to food pans 16 to warm the food contents of food pans 16. In alternative embodiments where food server 12 is to cool the food contents within pans 16, heat sources 28 may be omitted or possibly replaced with cooling mechanisms. Likewise, some of wells 20 may be provided with heating sources 28 while other of wells 20 omit heating sources 28.

Actuator 30 generally comprises a conventionally known or future developed actuation device configured to move drain valve 24 between the open position and the closed position in response to control signals from controller 32. Actuation device 30 may comprise one of a variety of known hydraulic, pneumatic, mechanical or electrically powered actuators. For example, actuator 30 may comprise a solenoid. In alternative embodiments, actuator 30 may be omitted wherein drain valve 24 is configured to be manually moved between the open and closed positions.

Controller 32 generally comprises a conventionally known or future developed processing unit that executes sequences of instructions contained in a memory. Execution of the sequences of instructions causes the processing unit to perform steps. The instructions may be loaded into a random access memory (RAM) for execution by the processing unit from a read only memory (ROM), a mass storage device, or some other persistent storage. In other embodiments, hard wired circuitry may be used in place of, or in combination with software instructions to implement the functions described. Controller 32 is not limited to any specific combination of hardware circuitry and software, nor to any particular source for the instructions executed by the processing unit.

Controller 32 communicates with actuator 30 and each of heat sources 28 via communication lines 33. In the particular embodiment, controller 32 communicates with actuator 30 and each of heat sources 28 via communication lines 33 comprising electrical wiring or cabling. In alternative embodiments, such communication lines 33 may comprise infrared or electromagnetic waves such as RF waves.

In the particular embodiment, each of heat sources 28 includes a sensor configured to sense the amount of heat transmitted by heat sources 28 which corresponds to a resulting temperature of fluid 46. Alternatively, the interior of wells 20 is provided with temperature sensors in direct contact with fluid 46 to sense the temperature of fluid 46. In such an alternative embodiment, the sensed temperature of fluid 46 is determined and communicated to controller 32. Controller 32 generates temperature control signals, wherein heat sources 28 vary the amount of heat provided to fluid 46 in response to such temperature control signals. As a result, the temperature of the fluid 46 within each of wells 28 may be controlled. The desired temperature setting may be pre-selected or may be manually input by a food server. In addition, controller 32 is also preferably configured to control the timing of the application of heat from heat sources 28 to fluid 26.

Controller 32 also generates drain valve control signals which are transmitted to actuator 30. Actuator 30 moves drain valve 24 between the open position and the closed position based upon such control signals. Controller 30 may generate such control signals in response to manual input or in response to signals from fluid level control system 14. As noted above, actuator 30 may alternatively be omitted wherein movement of valve 24 is performed manually.

Over time, fluid 46 within each of wells 20 evaporates or is changed into steam. As a result, the volume and level of fluid 46 within each of wells 26 drops, leading to non-optimal heating of food within food pans 16. Fluid level control system 14 detects drops in the volume or level of fluid 46 and supplies additional fluid to wells 20 to maintain the level of fluid 46 within each of wells 20 within a desired or optimal range. In contrast to known systems, fluid level control system 14 maintains the level of fluid 46 within a desirable range without requiring a large number of ports or openings within the walls of the wells and without requiring multiple inventories of wells. Fluid level control system 14 generally includes support structure 70, sensor 72, fill valve 74, controller 76, actuator 78 and overflow mechanism 80. Support structure 70 generally comprises a framework, housing or enclosure needed to support sensor 72, fill valve 74, controller 76, actuator 78 and overflow mechanism 80. Support structure 70 includes mounting mechanisms such as mounting brackets 82 which are configured to releasably couple support structure 70 to support structure 18 of server 12. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

As will be described later, any electrical or fluid connections required between system 14 and server 12 are also configured so as to be disconnectable or separable in nature, enabling fluid level control system 14 to be independently manufactured and easily assembled to a substantially independent server 12. Because support structure 70 enables system 14 to function as an independent unit, system 14 may be sold independent of unit 12 and may be provided as an upgrade to existing servers 12 out in the field. In lieu of being removably coupled to an exterior of support structure 18, support structure 70 may alternatively be configured to be inserted into the pre-existing cavity or recess or space within support structure 18. In alternative embodiments, each of the components of system 14 may be integrated into and supported by support structure 18 of server 12.

Sensor 72 generally comprises a conventionally known or future developed sensing device that is configured to identify or assist in identifying a volume of fluid within interior 50 of each well 20. Such identification may be achieved by directly detecting an exact level of fluid 46 within wells 20, by directly detecting a range in which the actual level of fluid 46 is within (i.e. above a certain point, below a certain point or between a lower point and an upper point) or by calculating or estimating a level of fluid 46 within interiors 50 of wells 20.

Sensor 72 is fluidly coupled to the interior 50 of each of wells 20, but is located external to wells 20 without requiring any additional ports or openings to be formed within the walls (floor 42 or side walls 44) of wells 20. In the particular embodiment illustrated, sensor 72 is fluidly coupled to drain manifold 22 external to wells 20. In the embodiment illustrated, system 14 includes sensor conduit 86 which extends from sensor 72 to a coupling point 88 so as to be joined to drain manifold 22. Coupling point 88, like coupling point 58, is configured to enable piping, tubing or fluid flow passages to be removably coupled to drain manifold 22 along an exterior portion of support structure 18. In alternative embodiments, sensor conduit 86 may be omitted where sensor 72 is directly coupled to drain manifold 22.

In operation, the opening of valves 26 enables fluid to flow past valves 26 into and out of wells 20. When valve 24 is closed, gravity equalizes the volume and level of fluid 46 within each of wells 20. Based upon the identified level of fluid within each of wells 20 by sensor 72, fill valve 74 actively facilitates the supply of fluid from a fluid source 90 to adjust the level of fluid within each of wells 20. In particular, fill valve 74 generally comprises a conventionally known or future developed valve mechanism which is configured to move between an open position in which fluid from fluid source 90 flows into drain manifold 22 and equally into each of wells 20 (for which valves 26 are open) and a closed position. Fill valve 74 moves between the open position and the closed position in response to the identified level of fluid 46 within each of wells 20. As shown by FIG. 2, fill valve 74 is situated along a fill conduit 92 which terminates at a coupling point 94 on structure 70. Coupling point 94 is similar to coupling points 58 and 88 and facilitates removable coupling of plumbing, hoses, tubing or other flow structures. In the particular embodiment shown, plumbing 96 is provided between the fluid source 90 and coupling point 94.

To facilitate movement of fill valve 74 between the open position and the closed position in response to the identified level of fluid 46 within each of wells 20, system 14 utilizes controller 76 and actuator 78. Controller 76 generally comprises a processor unit in communication with sensor 72 and with actuator 78. Controller 76 generally comprises a conventionally known or future developed processing unit that executes sequences of instructions contained in a memory. Execution of the sequences of instructions causes the processing unit to perform steps. The instructions may be loaded into a random access memory (RAM) for execution by the processing unit from a read only memory (ROM), a mass storage device, or some other persistent storage. In other embodiments, hard wired circuitry may be used in place of, or in combination with software instructions to implement the functions described. Controller 76 is not limited to any specific combination of hardware circuitry and software, nor to any particular source for the instructions executed by the processing unit. Controller 76 is configured to generate control signals based upon the identified level of fluid within wells 20.

Actuator 78 generally comprises a conventionally known or future developed actuation mechanism configured to move fill valve 74 between the open position and the closed position in response to the fill control signals from controller 76. Examples of actuator 78 include actuators that are powered electrically, pneumatically, hydraulically or mechanically. One particular example is a solenoid. Although less desirable, controller 76 may be omitted in particular embodiments wherein actuator 78 is configured to move fill valve 74 automatically in response to the level of fluid identified by sensor 72. For example, in particular embodiments, sensor 72 may comprise such structures as a float that moves based upon the level of water in wells 20. Movement of the float would cause a corresponding movement of a linkage connected to valve 74. Although controller 76 is illustrated as a processor unit distinct from controller 32, in alternative embodiments, controller 76 and controller 32 may be integrated into a single processor unit handling all operations.

FIG. 2 further illustrates additional optional features of station 10. In particular, as indicated by communication line 98, controller 76 may be configured to communicate with actuator 30 in lieu of or in addition to controller 32. In such a manner, controller 76 could be configured to generate control signals to open and close drain valve 24. For example, when fill valve 74 is in the open position, controller 76 could generate a control signal to ensure that drain valve 24 is closed. Alternatively, when instructions by controller 76 are to lower the level of fluid within wells 20, controller 76 could generate a control signal to cause drain valve 24 to open. Although not shown, controller 76 (or controller 32) could additionally be configured to communicate with additional actuators (not shown) coupled to valves 26. In such an alternative embodiment, individual control of the emptying and filling of individual wells 20 could be selectively controlled.

Overflow mechanism 80 generally comprises a mechanism configured to limit the total volume or level of fluid 46 within wells 50 in the event of failure of sensor 72, controller 76 and actuator 78 or valve 74. In particular, overflow mechanism 80 is configured to automatically drain fluid from wells 20 in the event that the level of fluid exceeds a predetermined amount. In the particular embodiment illustrated, drain conduit 100 terminates at an overflow coupling point 102 which serves as a connection point for a hose, tubing or other plumbing 104 to allow fluid to flow to drain 56. Although overflow mechanism 80 is illustrated as being fluidly coupled to drain manifold 22 by means of sensor conduit 86, overflow mechanism 80 may alternatively be directly fluidly coupled to drain manifold 22.

Food pans 16 generally comprise conventionally known or future developed pans configured to partially rest within wells 20 upon a platform 106 surrounding the opening in wells 20. Examples of food pans 16 are found in U.S. patent application Ser. No. 09/285,205 (now issued as U.S. Pat. No. 6,349,843); Ser. No. 09/540/563 (now issued as U.S. Pat. No. 6,415,945); Ser. Nos. 09/766,360 and 09/766,510, the full disclosures of such patent applications are hereby incorporated by reference.

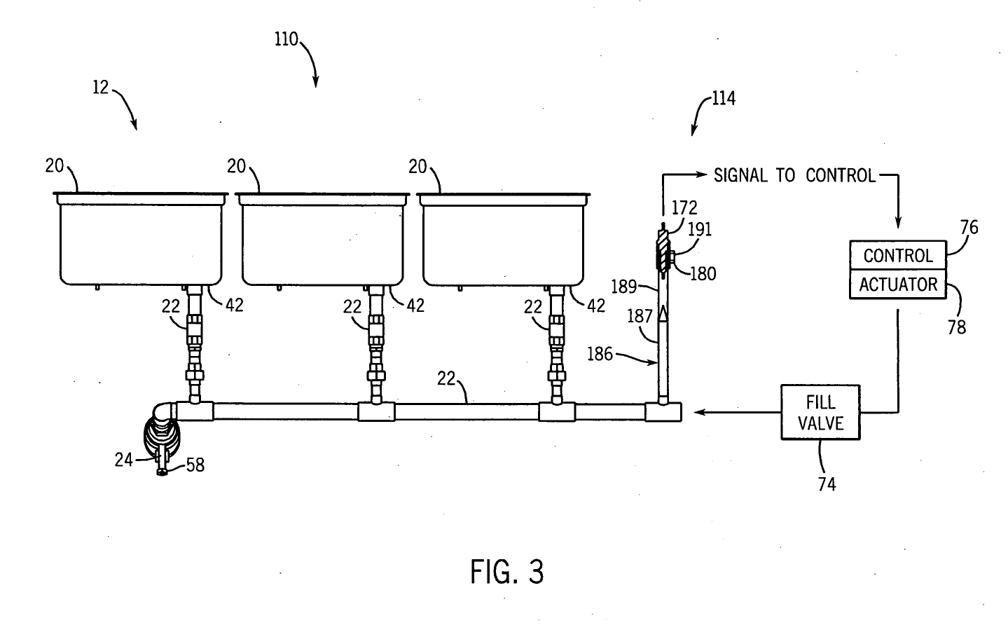

FIG. 3 is a side elevational view illustrating food serving station 110, a first alternative embodiment of food serving station 10 shown in FIGS. 1 and 2. For ease of illustration, portions of food serving station 110 which are previously described with respect to food serving station 10 are not shown. For example, FIG. 3 omits illustrating heat sources 28 and support structure 18. As shown by FIG. 3, food serving station 110 includes food server 112, fluid level control system 114 and food pans 16 (shown in FIG. 2). Although food server 112 is illustrated as omitting valves 26 and as utilizing a manually actuated drain valve 24 (omitting actuator 30 and controller 32), those additional elements may alternatively be provided as part of station 110. Those components of food serving station 110 which correspond to components of food serving station 10 are numbered similarly.

Fluid level control system 114 is similar to fluid level control system 14 except that fluid level control system 114 includes sensor conduit 186, sensor 172 and overflow mechanism 180 in lieu of conduit 86, sensor 72 and overflow mechanism 80, respectively. Sensor conduit 186 generally comprises a stand pipe or tube fluidly coupled to drain manifold 22 and extending vertically upward from a location vertically below at least one of floors 42 of wells 20 to a height above at least one of floors 42. As a result, gravity equalizes the level of fluid within conduit 86 with the level of fluid within wells 20. It should be noted that neither server 12 nor server 112 require that each of wells 20 be identical in size, shape or configuration. Although the level of fluid within wells 20 will generally be equal from the force of gravity, the volume of fluid within each well may differ due to differing configurations of the wells.

Sensor 172 is coupled to conduit 186 so as to identify the level or volume of fluid within wells 20 based upon the level or volume of fluid within conduit 186. In the particular embodiment illustrated, sensor 172 comprises a single point probe which projects into the interior of conduit 86 and is configured to detect the level of fluid within conduit 186. In one particular embodiment, the probe includes an electrical contact that is grounded out when the level of water within conduit 186 rises above the electrical contact. Grounding of the electrical contact results in a signal being transmitted to controller 76, indicating that the level of water within conduit 186 is at or above the location of the electrical contact of the probe. As a result, controller 76 generates a control signal and transmits a control signal to actuator 78 which moves fill valve 74 to the closed position. Once the level of fluid within conduit 186 has dropped below the electrical contact of probe 172, grounding no longer occurs which causes controller 76 to generate a control signal which is transmitted to actuator 78, whereby actuator 178 moves fill valve 74 to the open position to supply fluid to drain manifold 22 and to each of wells 20.

In alternative embodiments, sensor 172 may be replaced with an alternatively configured multiple point probe, wherein fill valve 74 is moved to the open position in response to the level of fluid within conduit 186 falling below a first point on the probe and in which fill valve 74 is moved to the closed position in response to the level of fluid within conduit 186 rising above a second point on the probe. In this manner, the level of fluid within conduit 186 and the level of fluid within wells 20 may be obtained within a pre-selected range. In particular embodiments, the extent to which fill valve 74 is opened, thereby regulating the rate at which fluid is supplied into wells 20, may be varied depending upon the sensed level of fluid in wells 20.

In lieu of comprising a probe which projects into the interior of conduit 186, sensor 172 may alternatively comprise other mechanisms for sensing or detecting the level of fluid within conduit 186. For example, sensor 172 may alternatively comprise an optical sensor which detects the level of fluid within conduit 186 using known optical sensing arrangements. In another embodiment, sensor 172 may comprise a float which moves within conduit 186 when the level of fluid within conduit 186 changes, wherein the sensed position of the float may be used to signal the level of fluid within conduit 186 and wells 20. For example, the float may be provided with a magnet facilitating detection of the position of the float within conduit 186 by a magnetic sensor element (e.g. the magnetic sensor elements conventionally used on bicycle odometers/speedometers). In other embodiments, the volume of fluid within conduit 186 may be sensed to identify the level of fluid within wells 20.

In the particular embodiment shown in FIG. 3, the predetermined level (such as with a single point probe) or predetermined levels (such as with a multiple point probe) that are compared with the identified level of fluid within wells 20 to initiate the opening and closing of fill valve 74 are adjustable. In the particular embodiment illustrated, sensor conduit 186 includes a first portion 187 and a second portion 189 which are telescopically adjustable relative-to one another so as to move sensor 172 vertically up and down to enable adjustment of the level at which fill valve 74 is opened and closed. In alternative embodiments, sensor 172 may be movable relative to conduit 186. In still other embodiments, sensor 172 itself may have adjustable settings. In still further embodiments, sensor 172 may be configured to detect multiple levels or a continuous range of levels of fluid within conduit 186, wherein controller 76 is provided with a set of instructions (e.g. software or hard wired) which result in fill valve 74 being opened and closed by actuator 78 in response to predetermined, adjustable trigger levels established by controller 76.

Overflow mechanism 180 generally comprises an overflow port 191 fluidly coupled to fluid conduit 186 at a height corresponding to a predetermined maximum allowed level of fluid within wells 20. As a result, when the level of fluid within conduit 186 (and also within wells 20) rises to a level or height exceeding the maximum allowed level, the fluid is automatically discharged through port 191 eventually to drain 56 (shown in FIG. 2). In the particular embodiment illustrated, adjustment of portion 189 relative to portion 187 also adjusts the maximum allowed level provided by overflow mechanism 180. In alternative embodiments, overflow mechanism 180 may be configured to be independently adjusted relative to portion 189 or the height of sensor 172.

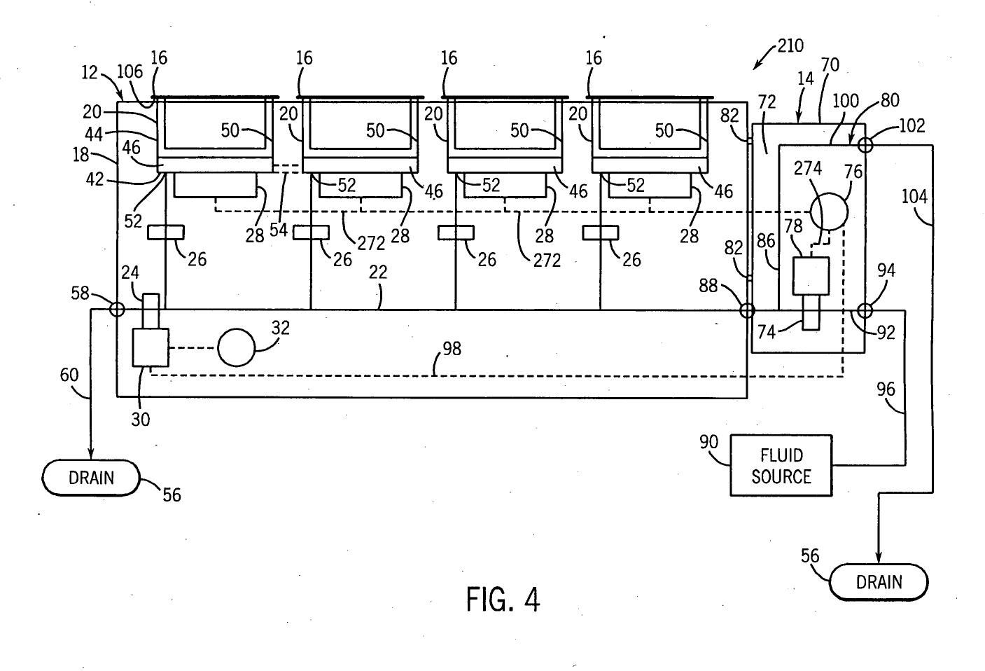

FIG. 4 is a schematic illustration of food serving station 210, a second alternative embodiment of food serving station 10. Food serving station 210 is similar to food serving station 10 except that food serving station 210 omits sensor 72 and conduit 86 (overflow conduit 100 is extended) and additionally includes communication line 272. Communication lines 272 schematically depict communication between controller 76 and heat sources 28. Such communication may be provided by direct electrical wiring or may be provided by infrared or radio waves. Via communication line 272, controller 76 receives information in the form of signals from heat sources 28 indicating the rate at which heat is supplied to fluid 46 and well as the duration at which heat is provided to fluid 46. Based on such information, controller 76 is configured to calculate the rate at which the level of fluid 46 within wells 20 drops. Controller 76 is in further communication with actuator 78 as indicated by communication line 274 (also shown in FIG. 2). Via this communication line, controller 76 also receives information regarding duration in which fill valve 74 has been in the open position allowing fluid to flow into wells 20. Utilizing a predetermined or preknown rate of fluid flow through valve 74 or a sensed rate of fluid flow through valve 74, controller 76 estimates the volume of fluid input provided to wells 20. By determining the volume of fluid supplied to wells 20 as well as the rate at which fluid has been evaporated or otherwise dissipated from wells 20, controller 76 calculates or estimates the level of fluid within wells 20. Based upon this calculated level, controller 76 generates fill control signals to cause actuator 78 to open or close valve 74 to maintain an appropriate or desired level of fluid 46 within wells 20.

In lieu of estimating the rate fluid is evaporated or the volume of fluid evaporated from wells 20 utilizing information regarding the amount of heat supplied to wells 20 by heat source 28, controller 76 may alternatively communicate with sensors located directly within well 20 or other sensors configured to sense evaporation of fluid within wells 20.

Each of food serving stations 10, 110 and 210 maintain a desired level of fluid within wells 20 without requiring specially configured wells requiring multiple openings or ports through the wells. In the embodiment shown, wells 20 merely require a single opening, drain port 52. In contrast to known systems, the wells 20 of stations 10, 110 and 210 do not require a port or opening for filling wells 20, do not require an additional opening or port for use with a water level sensor and do not require an additional opening or port for an overflow. Instead, stations 10, 110 and 210 utilize drain ports 52 for filling all of the wells fluidly coupled to drain manifold 22, utilize a sensor that is external and does not pass through any of the walls and utilize an overflow mechanism that is also external to all the wells. Although less desirable, stations 10, 110 and 210 may alternatively employ only some of these beneficial features independent of the use of the other beneficial features. For example, in lieu of employing an overflow mechanism fluidly coupled to drain manifold 22 external of wells 20, any one of stations 10, 110 or 210 may alternatively utilize overflow drain port and overflow mechanism formed in at least one of the walls of wells 20. In lieu of utilizing a sensor that is fluidly coupled to wells 20 indirectly through drain manifold 22 external to wells 20, any one of stations 10, 110 and 210 may alternatively utilize a fluid level sensor directly within one or more of wells 20 for extending through the walls of one or more wells 20. In lieu of filling all of wells 20 through drain manifold 22, one or more wells 20 may alternatively include a fill port fluidly coupled to a fluid source and a fill valve, wherein the fill port is in addition to drain port 52. Each of the architectures described eliminating either an additional fill port, an additional overflow port or an additional sensor port may be used independent of one another or in various combinations with one another to achieve various degrees of beneficial results.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the above definitions is manifestly intended to be as broad as possible. For example, unless specifically otherwise noted, the definitions reciting a single particular element also encompass a plurality of such particular elements.

What is claimed is:

1. A fluid level control system for use with a server having one or more wells and a drain manifold fluidly communicating with an interior of each of the one or more wells and not fluidly communicating with any other wells, the system comprising:
a fill valve adapted to be coupled to the drain manifold external the one or more wells and adapted to be coupled to a fluid source, wherein the valve is movable between an open position in which fluid from the fluid source is permitted to flow into the manifold and a closed position;
at least one sensor configured to identify a volume of fluid within the interior of the one or more wells, wherein the fill valve moves between the open position and the closed position based upon the identified volume of fluid within the interior of the one or more wells.

2. The system of claim 1, wherein the server includes a first support structure supporting the one or more wells and wherein the system includes a second support structure supporting the fill valve and the at least one sensor as a unit distinct from the first support structure, wherein the second support structure is adapted to be removably coupled to the first support structure.

3. The system of claim 1 including:
a processor coupled to the sensor and configured to generate control signals based upon the identified volume of fluid; and
an actuator coupled to the fill valve, wherein the actuator actuates the fill valve between the open position and the closed position in response to the control signals from the processor.

4. The system of claim 1 including an overflow conduit.

5. The system of claim 1, wherein the at least one sensor is configured to detect a level of fluid within the interior of the one or more wells.

6. The system of claim 3, wherein the at least one sensor is configured to detect when the level of fluid is less than a preselected level, wherein the fill valve is moved to the open position in response to the level of fluid being less than the preselected level.

7. The system of claim 6, wherein the preselected level is adjustable.

8. The system of claim 5, wherein the at least one sensor is configured to detect when the level of fluid is greater than a preselected level, wherein the fill valve is moved to the closed position in response to the level of being greater than the preselected level.

9. The system of claim 8, wherein the preselected level is adjustable.

10. The system of claim 3, wherein the at least one sensor is configured to detect when the level of fluid is less than the first preselected level and when the level of fluid is greater than a second preselected level, wherein the fill valve moves to the open position in response to the level of fluid being less than the first preselected level and wherein the fill valve moves to the closed position in response to the level of fluid being greater than the second preselected level.

11. The system of claim 10, wherein at least one of the first preselected level and the second preselected level are adjustable.

12. A food serving station comprising:
a first support structure;
one or more wells supported by the first support structure;
a drain manifold fluidly coupled to each of the one or more wells and not fluidly coupled to any other wells; and
an overflow conduit fluidly coupled to the drain manifold and external to the one or more wells.

13. The station of claim 12 including a fill valve fluidly coupled to the drain manifold and adapted to be coupled to a fluid source, wherein the fill valve is movable between an open position in which fluid from the fluid source is permitted to flow into the manifold and a closed position.

14. The station of claim 13 including at least one sensor configured to identify a volume of fluid within the one or more wells, wherein the fill valve moves between the open position and the closed position to a sensed volume of fluid within the one or more wells.

15. The station of claim 14 including:
a processor coupled to the at least one sensor and configured to generate control signals based upon the identified volume of fluid within the one or more wells; and
an actuator coupled to the fill valve, wherein the actuator moves the fill valve between the open position and the closed position in response to the control signals from the processor.

16. The station of claim 14, wherein the at least one sensor is external to the one or more wells.

17. The station of claim 16 including a sensor in fluid communication with an interior of the drain manifold, wherein the sensor is at least partially within the sensor conduit.

18. The station of claim 14, wherein the sensor is configured to detect a level of fluid within the one or more wells.

19. The station of claim 18, wherein the at least one sensor is configured to detect when the level of fluid is less than a preselected level, wherein the fill valve is moved to the open position in response to the level of fluid being less than the preselected level.

20. The station of claim 19, wherein the preselected level is adjustable.

21. The station of claim 14, wherein the at least one sensor is configured to detect when the level of fluid is greater than a preselected level, wherein the fill valve is moved to the closed position in response to the level of being greater than the preselected level.

22. The station of claim 21, wherein the preselected level is adjustable.

23. The station of claim 14, wherein the at least one sensor is configured to detect when the level of fluid is less than the first preselected level and when the level of fluid is greater than a second preselected level, wherein the fill valve moves to the open position in response to the level of fluid being less than the first preselected level and wherein the fill valve moves to the closed position in response to the level of fluid being greater than the second preselected level.

24. The station of claim 23, wherein at least one of the first preselected level and the second preselected level are adjustable.

25. The station of claim 12 including at least one heat source supported below the one or more wells and configured to heat fluid within the one or more wells.

26. The station of claim 12 including a processor configured to calculate a volume of fluid within the one or more wells based upon a volume of fluid supplied to the one or more wells from a fluid source and an amount of fluid removed from the one or more wells.

27. The station of claim 26, wherein the processor calculates the amount of fluid removed from within the one or more wells based upon an estimated or sensed rate of evaporation of the fluid.

28. The station of claim 27 including:
at least one heat source supported below the one or more wells and configured to heat the fluid within the one or more wells; and
a temperature sensor configured to sense the temperature of the fluid within the one or more wells and/or heat emitted from the heat source, wherein the processor is coupled to the temperature sensor.

29. A food serving station comprising:
a first support structure;
one or more wells supported by the first support structure;
a drain manifold fluidly coupled to each of the one or more wells and not fluidly coupled to any other wells; and
a fill valve coupled to the drain manifold and external to the one or more wells.

30. The station of claim 29 including at least one sensor configured to identify a volume of fluid within the one or more wells, wherein the fill valve moves between the open position and the closed position to a sensed volume of fluid within the one or more wells.

31. The station of claim 30 including a sensor conduit in fluid communication with an interior of the drain manifold, wherein the at least one sensor is at least partially within the sensor conduit.

32. The station of claim 30 including:
a processor coupled to the at least one sensor and configured to generate control signals based upon the identified volume of fluid within the one or more wells; and
an actuator coupled to the fill valve, wherein the actuator moves the fill valve between the open position and the closed position in response to the control signals from the processor.

33. The station of claim 29, wherein the at least one sensor is configured to detect a level of fluid within the one or more wells.

34. The station of claim 30, wherein the at least one sensor is configured to detect when the level of fluid is less than a preselected level, wherein the fill valve is moved to the open position in response to the level of fluid being less than the preselected level.

35. The station of claim 34, wherein the preselected level is adjustable.

36. The station of claim 30, wherein the at least one sensor is configured to detect when the level of fluid is greater than a preselected level, wherein the fill valve is moved to the closed position in response to the level of being greater than the preselected level.

37. The station of claim 36, wherein the preselected level is adjustable.

38. The station of claim 30, wherein the at least one sensor is configured to detect when the level of fluid is less than the first preselected level and when the level of fluid is greater than a second preselected level, wherein the fill valve moves to the open position in response to the level of fluid being less than the first preselected level and wherein the fill valve moves to the closed position in response to the level of fluid being greater than the second preselected level.

39. The station of claim 38, wherein at least one of the first preselected level and the second preselected level are adjustable.

40. The station of claim 29 including at least one heat source supported below the one or more wells and configured to heat fluid within the one or more wells.

41. The station of claim 29, including at least one sensor configured to identify a volume of fluid supplied to the one or more wells from a fluid source, wherein the station further includes a processor configured to calculate the volume of fluid within the one or more wells based upon the identified volume of fluid supplied to the one or more wells from the fluid source.

42. The station of claim 41, wherein the processor calculates the volume of fluid within the one or more wells additionally based upon an estimated or sensed rate of evaporation of the fluid.

43. The station of claim 42 including:
at least one heat source supported below the one or more wells and configured to heat the fluid within the one or more wells; and
a temperature sensor configured to sense the temperature of the fluid within the one or more wells and/or heat emitted from the heat source, wherein the processor is coupled to the temperature sensor.

44. A food serving station comprising:
a first support structure;
one or more wells supported by the first support structure;
a drain manifold fluidly coupled to each of the one or more wells and not fluidly coupled to any other wells;
a fill valve adapted to be coupled to a fluid source and configured to supply fluid to the one or more wells, wherein the fill valve moves between an open position in which fluid from the fluid source is permitted to flow into the one or more wells and a closed position; and
at least one sensor fluidly coupled to the one or more wells and external to the one or more wells, the at least one sensor being configured to identify a volume of fluid within the one or more wells, wherein the fill valve moves between the open position and the closed position based upon the identified volume of fluid within the one or more wells.

45. The station of claim 44, wherein the server includes a first support structure supporting the one or more wells and wherein the system includes a second support structure supporting the fill valve and the at least one sensor as a unit distinct from the first support structure, wherein the second support structure is adapted to be removably coupled to the first support structure.

46. The station of claim 44 including:
a processor coupled to the sensor and configured to generate control signals based upon the identified volume of fluid; and
an actuator coupled to the fill valve, wherein the actuator actuates the fill valve between the open position and the closed position in response to the control signals from the processor.

47. The station of claim 44 including:
a first support structure supporting the one or more wells; and
a second support structure supporting the fill valve and the at least one sensor as a unit distinct from the first support structure, wherein the second support structure is removably coupled to the first support structure.

48. The station of claim 44, wherein the at least one sensor is configured to detect a level of fluid within the interior of the one or more wells.

49. The station of claim 48, wherein the at least one sensor is configured to detect when the level of fluid is less than a preselected level, wherein the fill valve is moved to the open position in response to the level of fluid being less than the preselected level.

50. The station of claim 49, wherein the preselected level is adjustable.

51. The station of claim 44, wherein the at least one sensor is configured to detect when the level of fluid is greater than a preselected level, wherein the fill valve is moved to the closed position in response to the level of being greater than the preselected level.

52. The station of claim 51, wherein the preselected level is adjustable.

53. The station of claim 44, wherein the at least one sensor is configured to detect when the level of fluid is less than the first preselected level and when the level of fluid is greater than a second preselected level, wherein the fill valve moves to the open position in response to the level of fluid being less than the first preselected level and wherein the fill valve moves to the closed position in response to the level of fluid being greater than the second preselected level.

54. The station of claim 53, wherein at least one of the first preselected level and the second preselected level are adjustable.

55. The station of claim 44 including at least one heat source supported below the one or more wells and configured to heat fluid within the one or more wells.

56. The station of claim 44 including:
at least one sensor configured to identify a volume of fluid supplied to the one or more wells from a fluid source; and
a processor configured to calculate the volume of fluid within the one or more wells based upon the sensed volume of fluid supplied to the one or more wells from the fluid source.

57. The station of claim 56, wherein the processor calculates the volume of fluid within the one or more wells additionally based upon an estimated or sensed rate of evaporation of the fluid.

58. The station of claim 57 including:
at least one heat source supported below the one or more wells and configured to heat the fluid within the one or more wells; and
a temperature sensor configured to sense the temperature of the fluid within the one or more wells and/or heat emitted from the heat source, wherein the processor is coupled to the temperature sensor.

59. A food serving station comprising:
a support structure;
one or more wells having walls forming one or more interiors;
a drain outlet in fluid communication with the one or more interiors;
an overflow outlet in fluid communication with the one or more interiors; and
at least one sensor configured to identify a volume of fluid within at least one of the one or more wells, wherein no greater than two of the drain outlet, the overflow outlet and the at least one probe requires ports through the walls.

60. A method for controlling a level of fluid contained within one or more wells of a server having a drain manifold coupled to the one or more wells and not coupled to any other wells, the method comprising:
determining a level of fluid within the one or more wells by sensing a level of fluid external to the one or more wells; and
adjusting the level of fluid within the one or more wells based upon the determined level of fluid external to the one or more wells.

61. A method for supplying fluid to an interior of one or more wells having a drain manifold fluidly coupled to the one or more wells and a drain, the method comprising:
blocking fluid flow from a drain manifold into the drain; and
supplying fluid into the drain manifold at a location external to the one or more wells.
